(19) United States
(12) Patent Application Publication
(10) Pub. No.: US 2005/0130026 A1
(43) Pub. Date: Jun. 16, 2005

(54) Electrochemical battery, electrode therefor and method for manufacturing the same

(76) Inventors: Tae-Hee Cho, Changwon (KR); Myung-Seok Park, Jinhae (KR); Kyu-Jung Kim, Sungnam (KR); Myeong-Ho Lee, Busan (KR); Cheol-Hwan Kim, Gimhae (KR); Seung-Tae Ko, Daegu (KR); Seong-Geun Heo, Busan (KR); Sam-Chul Ha, Changwon (KR)

Correspondence Address: FLESHNER & KIM, LLP, P.O. BOX 221200, CHANTILLY, VA, 20153, US

(21) Appl. No.: 10/732,804

(22) Filed: Dec. 11, 2003

(51) Int. Cl. H01M 4/86; H01M 4/90; H01M 4/58; H01M 4/62; H01M 4/88

(52) U.S. Cl. 429/44; 429/218.2; 429/42; 429/217; 502/101

(57) ABSTRACT

An electrode of an electrochemical battery includes: an electrode catalyst and a catalyst holding body for holding and confining the electrode catalyst by being entangled with the electrode catalyst. A fabrication method of the electrode is simple, and the electrode has a small volume, high flexibility and durability. A specific surface area of the electrode catalyst is large and an efficiency of the battery can be improved.

### BACKGROUND OF THE INVENTION

1. Field of the Invention

The present invention relates to an electrochemical battery and, more particularly, to an electrode of an electrochemical battery.

2. Description of the Conventional Art

In general, a battery is to convert chemical energy to electric energy by using a contact potential difference between suitable materials.

There are various kinds of batteries which can be technically classified into a primary battery, a secondary battery, a fuel cell and solar battery.

The primary battery, such as, a manganese battery, an alkali battery, a mercury battery, a silver oxide battery,. performs only a discharging reaction to convert chemical energy into electric energy. The secondary battery can be used by being repeatedly charged and discharged differing from the primary battery having only one time discharging reaction. The fuel cell converts combustion heat of fuel such as hydrogen or hydrocarbon as it is into electric energy. The solar battery converts light energy to electric energy.

FIG. 1 is a schematic view showing an example of a general fuel cell.

As shown in FIG. 1, the fuel cell includes a fuel electrode (anode) 14 and an oxygen electrode (cathode) 16 with electrolyte interposed therebetween.

In the fuel cell with such a structure, a fuel such as hydrogen is supplied to the fuel electrode 14 through a fuel supply pipe 13 and at the same time oxidant such as oxygen or air is supplied to the oxygen electrode 16 through an oxidant supply pipe 17.

At this time, electrons are discharged with the aid of a catalyst and oxidation takes place in the anode 14. The electrons generated from the anode 14 are transferred to the cathode 16 by way of a load 18 connected to the anode 14 and the cathode 16.

In the cathode 16, as a reduction reaction takes place with the electrons transferred by the aid of the catalyst, the oxidant is reduced.

Positive ions/negative ions are transferred from the anode 14 to the cathode 16 or from the cathode 16 to the anode 14 through the electrolyte 12 interposed between the anode 14 and the cathode 16.

In particular, if hydrogen is used as the fuel, as the fuel cell operates, ionization of hydrogen proceeds to hydrogen ions H⁺ and electrons e⁻ in the anode 14, and H⁺ generated in the anode 14 is moved to the cathode 16 through the electrolyte and the electrons e^{- are transferred to an external load 18 through the anode 14.}

In the cathode 16, H⁺ transferred through the electrolyte 12 reacts with oxygen in the air, generating water together with heat of reaction, which is expressed as the following reaction formula:
Fuel electrode/anode: H₂(g)→2H⁺+2e⁻
Oxygen electrode/cathode: ½O₂(g)+2H⁺+2e⁻→H₂O(I)
Total reaction formula: H₂(g)+½O₂(g)→H₂O(I)

In the fuel cell, generally, a load is connected to the anode 14 and the cathode 16. When the fuel cell operates, electrons e⁻ are continuously generated from the anode 14 and flows to the cathode 16 through the load, that is, as electrons are transferred from the anode 14 to the cathode 16, a current is generated to operate an electric device or the like.

Meanwhile, the type of electrode used as the cathode or the anode of the electrochemical battery such as the fuel cell greatly affects the performance of the battery such as a lifespan of the battery or its output according to its material and characteristics.

FIG. 2 shows a structure of the electrode of the conventional fuel cell.

As shown in FIG. 2, the electrode 20 of the conventional fuel cell includes a foam body 23 made of Ni in which mixture of electrode catalyst particles 21 made of metal halide (MH), and polytetrafluoro ethylene 22, as fluoride polymer, is infiltrated, and a mesh 24 made of Ni enclosing the foam body 23.

In detail, the granule type electrode catalyst 21 and PTFE(Poly Tetrafluoro Ethylene) 22 are mixed to a mixture 25 which is infiltrated in the foam body 23 to fill the void parts of the foam body 23.

The foam body 23 filled with the mixture 25 of electrode catalyst 21 and PTFE 22 is enclosed by the mesh 24 which maintains the shape of the foam body 23, protects the foam body 23 and has fine holes for preventing the electrode catalyst 21 and PTFE 22 from being separated, and then is pressed by using a roller to thereby process the electrode 20.

However, the electrode 20 constructed and fabricated as described above has a problem that since the mesh 24 is additionally used to prevent the electrode atalyst 21 or PTFE 22 from being separated from the foam body 23, a specific surface area of the electrode catalyst 21 is reduced, to cause the volume and weight of the electrode to be relatively increased in its fabrication to meet a required performance.

In addition, an incomplete combination between the electrode catalyst 21 and PTFE 22 weakens durability, and in case of being used as the electrode 20, the electrode catalyst 21 is separated from the electrode 20, thus degrading the performance as the electrode.

### SUMMARY OF THE INVENTION

Therefore, it is an object of the present invention to provide an electrochemical battery, an electrode therefore and a method for manufacturing the electrode that are capable of providing a simple manufacturing method, reducing volume, increasing flexibility, durability and specific surface area of an electrode catalyst, and heightening an efficiency of a battery.

To achieve the above object, there is provided an electrode of an electrochemical battery including: an electrode catalyst; and a catalyst holding body for holding and confining the electrode catalyst by being entangled with the electrode catalyst.

To achieve the above object, there is also provided a method for fabricating an electrode of electrochemical battery, including: a first step of fabricating a catalyst holding body having fine spaces; and a second step of holding and confining an electrode catalyst in the catalyst holding body, the catalyst holding body and the power type electrode catalyst being entangled with each other.

To achieve the above objects, there is also provided a battery having such an electrode as described above.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view showing an example of a general fuel cell;

FIG. 2 is a view showing a structure of an electrode of a fuel cell in accordance with a conventional art;

FIG. 3A is a schematic view showing a construction of an electrode of an electrochemical battery in accordance with the first embodiment of the present invention;

FIG. 3B is a view showing an enlarged portion of FIG. 3A;

FIG. 4 is a schematic view showing a modification of the electrode of an electrochemical battery of FIG. 3A;

FIG. 5 is a sectional view showing the electrode having a housing enclosing the electrode of FIG. 3A;

FIG. 6 is a schematic view showing a construction of an electrode of an electrochemical battery in accordance with the second embodiment of the present invention;

FIG. 7 is a flow chart of a process of manufacturing the electrochemical battery of FIG. 3A; and

FIG. 8 is a flow chart of a process of manufacturing the electrochemical battery of FIG. 6.

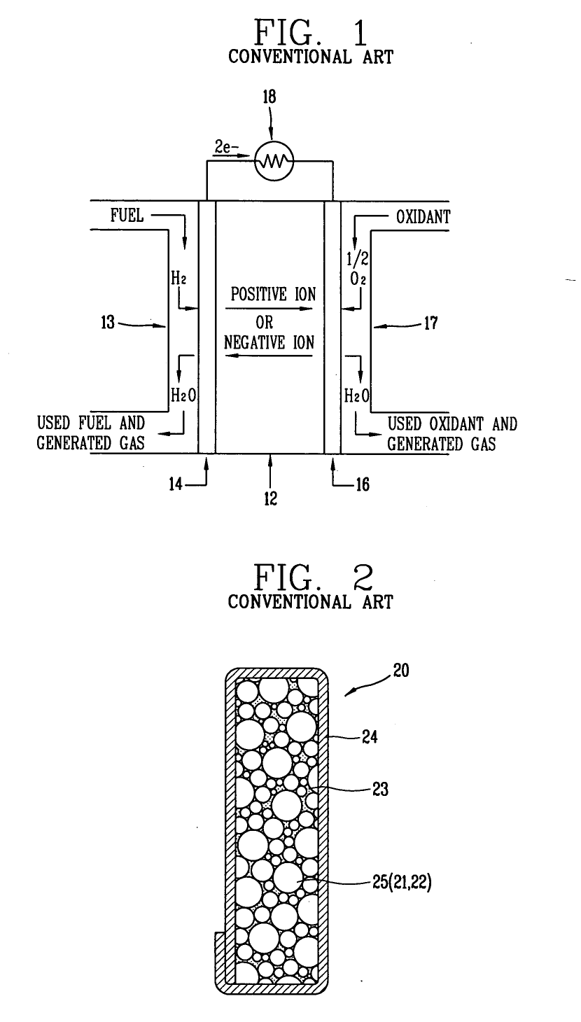

### DETAILED DESCRIPTION OF THE PREFERRED EMBODIMENTS

An electrochemical battery, electrode therefore and a method for manufacturing the same will now be described in detail with reference to the accompanying drawings.

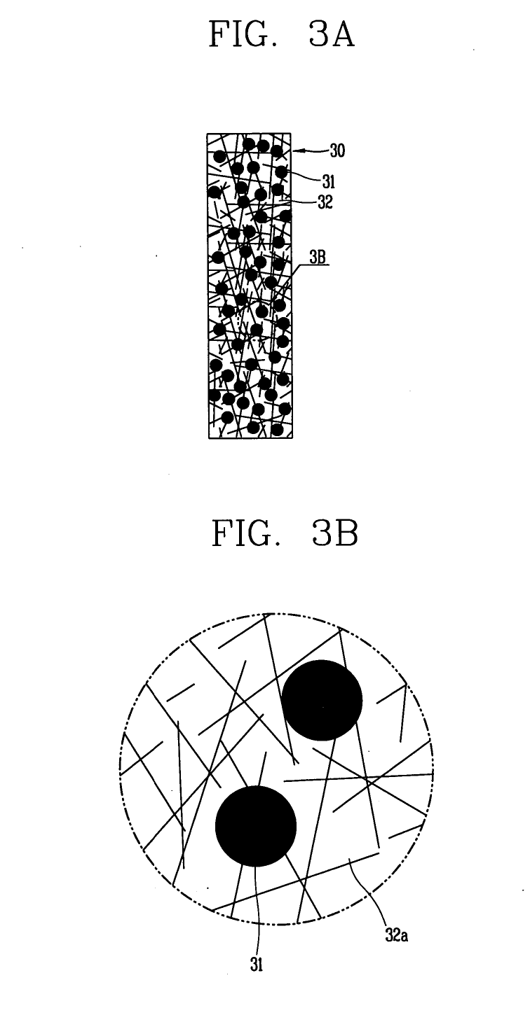

FIG. 3A is a schematic view showing a construction of an electrode of an electrochemical battery in accordance with the first embodiment of the present invention; and FIG. 3B is a view showing an enlarged portion of FIG. 3A.

As shown in FIGS. 3A and 3B, an electrode 30 of an electrochemical battery in accordance with the first embodiment of the present invention includes an electrode catalyst 31, and, i.e., a catalyst holding body 32 made of a fiber stack of conductive metal material to which the electrode catalyst 31 is attached.

As the electrode catalyst 31, a hydrogen storage alloy such as metal halide is preferably used.

The electrode catalyst 31 can be transformed to various forms. It has a fiber form such as a filament, and preferably a granule form.

Preferably, the electrode catalyst 31 is coated with nickel on its surface. Especially, if the catalyst holding body 32 (to be described) is made of nickel or nickel alloy material, the electrode catalyst 31 and the catalyst holding body 32 are made of the same material so that the electrode catalyst 31 can be more firmly adhered in the catalyst holding body 32 and confined within the catalyst holding body 32, and thus, separation of the electrode catalyst 31 from the catalyst holding body 32 can be prevented.

In particular, the electrode catalyst 31 needs to be subjected to a surface processing for improvement of performance. If the electrode catalyst 31 is coated with Ni, which is the same material as that of the catalyst holding body 32, the adhesiveness of the electrode catalyst 31 to the catalyst holding body 32 is increased compared to the electrode catalyst processed with fluoride.

The catalyst holding body 32 is made of conductive metal material, and preferably, it is made of nickel or nickel alloy. Especially, the electrode 31 itself can be a fiber stack to constitute the catalyst holding body 32.

A diameter and a length of each of the fibers constituting the catalyst holding body 32 can be determined depending on usage conditions of the electrode. In the preferred embodiment of the present invention, the diameter of the fiber of the catalyst holding body 32 is 1 to 100 μm and its length is 10 to 10,000 μm.

As shown in FIG. 3B, the catalyst holding body 32 can be a fiber sintered body resulting from sintering fibers 32a of conductive metal material or a non-woven fabric made of conductive metal material.

Especially, as the catalyst holding body and its manufacturing method, the present invention uses a method for fabricating a stack of fine metallic threads and metal fiber sintered body as disclosed in Korean Patent Publication No. 10-2001-0086569 or Korean Patent Publication No. 10-2001-0018726, but it is not limited thereto.

Accordingly, the catalyst holding body 32 can be formed as a porous tissue and the porous tissue can be implemented as one line.

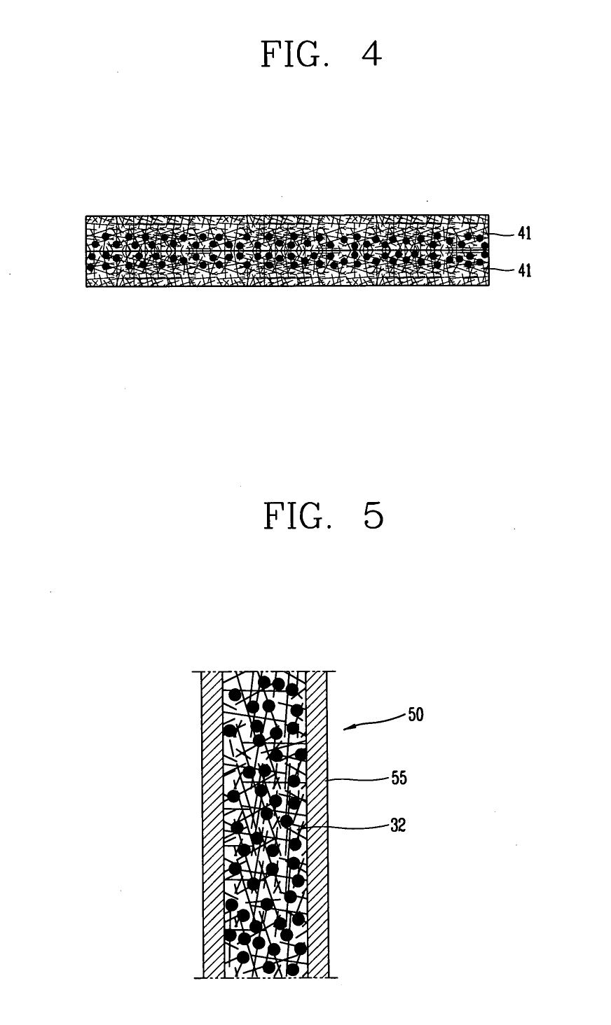

As shown in FIG. 4, the catalyst holding body 32 can be constructed as a pair of sheets 41 with the electrode catalyst 31 infiltrated with a certain depth and attached only at one side. The pair of sheets 41 can be mutually overlapped in such a manner that the sides where the electrode catalyst 31 is attached meet together.

As shown in FIG. 5, the electrode 50 of the electrochemical battery in accordance with the present invention may additionally include a housing 55 which accommodates the catalyst holding body 32, is made of conductive metal material and has a plurality of holes.

The housing 55 having a plurality of holes may be a mesh, and the housing 55 is preferably fabricated with nickel or nickel alloy.

The catalyst holding body 32 may additionally include a fluoro polymer (not shown) such as PTFE.

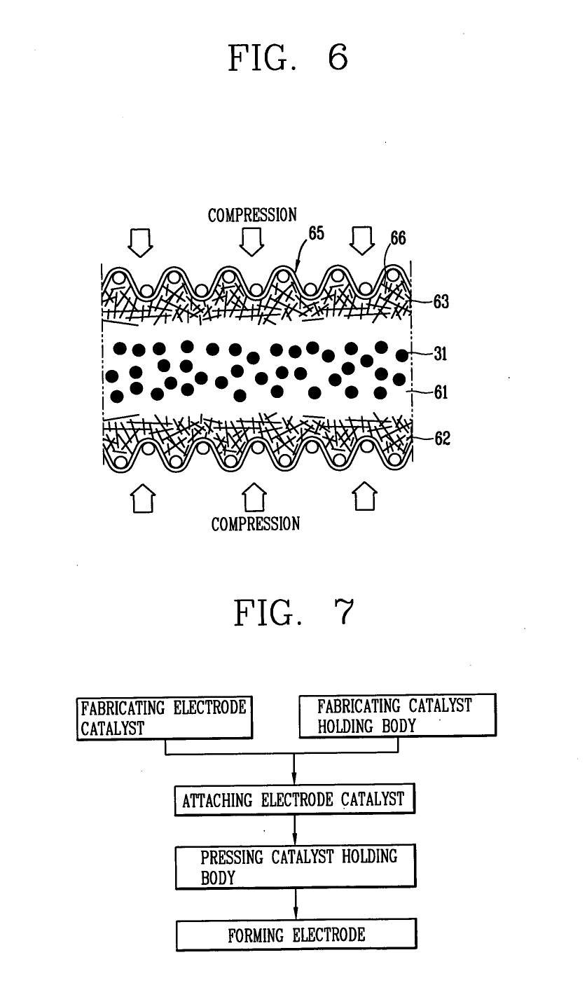

FIG. 6 is a schematic view showing a construction of an electrode of an electrochemical battery in accordance with the second embodiment of the present invention.

The electrode of an electrochemical battery of the present invention can be constructed with the electrode catalyst and the catalyst holding body each formed as a layer. That is, as shown in FIG. 6, an electrode 60 of an electrochemical battery in accordance with the second embodiment of the present invention includes an electrode catalyst layer 61 having electrode catalyst 31 and a pair of first and second catalyst holding bodies 62 and 63 which are formed with the electrode catalyst layer 61 interposed therebetween and made of a fiber stack.

As the electrode catalyst 31, a hydrogen storage alloy such as metal halide (MH) is preferably used. The electrode catalyst layer 61 may contain a fluoro polymer 64 such as PTFE in addition to the electrode catalyst 31. PTFE has the effect of restraining the generation of hydrogen. That is, the electrode catalyst layer 61 can be constructed with a mixture of the electrode catalyst 31 and PTFE.

The electrode catalyst 31 can be transformed to various forms. It has a fiber form such as a filament, and preferably a granule form.

Preferably, the electrode catalyst 31 is coated with nickel on its surface. In this respect, especially, if the first and second catalyst holding bodies 62 and 63 are made of nickel or nickel alloy material, the electrode catalyst 31 and the first and second catalyst holding bodies 62 and 63 are made of the same material, so that the electrode catalyst 31 can be more firmly adhered to the first and second catalyst holding bodies 62 and 63, thus, separation of the electrode catalyst 31 from the catalyst holding bodies 62 and 63 can be prevented.

In particular, the electrode catalyst 31 needs to be subjected to a surface processing for improvement of a performance. If the electrode catalyst 31 is coated with Ni, which is the same material as that of the first and second catalyst holding bodies 62 and 63, the adhesiveness of the electrode catalyst 31 to the catalyst holding body 32 is increased compared to the electrode catalyst processed with fluoride.

The first and second catalyst holding bodies 62 and 63 are made of conductive metal material, and preferably, they are made of nickel or nickel alloy.

A diameter and a length of each of the fibers constituting the first and second catalyst holding bodies 62 and 63 can be determined depending on usage conditions of the electrode. In the preferred embodiment of the present invention, the diameters of the fiber of the first and second catalyst holding bodies 62 and 63 are 1 to 100 μm and the lengths are 10 to 10,000 μm.

As shown in FIG. 6, the first and second catalyst holding bodies 62 and 63 can be a fiber sintered body resulting from sintering fibers 32a of conductive metal material or a non-woven fabric made of a conductive metal material.

Especially, as the catalyst holding body and its manufacturing method, the present invention uses a method for fabricating a fine metallic thread and metal fiber sintered body as disclosed in Korean Patent Publication No. 10-2001-0086569 or Korean Patent Publication No. 10-2001-0018726, but it is not limited thereto.

As shown in FIG. 6, the electrode 50 of the electrochemical battery in accordance with the second embodiment of the present invention may additionally include a housing 65 which accommodates the catalyst holding body 32, is made of conductive metal material and has a plurality of holes.

The housing 65 having a plurality of holes may be a mesh, and the housing 65 is preferably fabricated with nickel or nickel alloy.

The battery in accordance with the second embodiment of the present invention can be applied in the same way except for the descriptions for the battery in accordance with the first embodiment.

The method for manufacturing an electrode of an electrochemical battery in accordance with the present invention will now be described in detail.

FIG. 7 is a flow chart of a process of manufacturing an electrochemical battery of FIG. 3A.

First of all, fabrication of the catalyst holding body 32 is of importance. As described above, it needs to be fabricated to form a fiber stack made of conductive metal material, especially, nickel or nickel alloy material. The fiber stack and its manufacturing method are as disclosed in Korean Patent Publication No. 10-2001-0086569 and Korean Patent Publication No. 10-2001-0018726.

As shown in FIG. 7, the method for manufacturing the electrode of an electrochemical battery in accordance with the first embodiment of the present invention including the steps of: attaching the electrode catalyst 31 to the catalyst holding body 32 made of a fiber stack of conductive metal material; and forming the electrode catalyst-attached catalyst holding body 32 as an electrode 30 of an electrochemical battery.

The electrode catalyst 31 preferably can have a filament form, and more preferably a granule form.

In the attaching step, the catalyst holding body 32 is put in a solution, and them onto which the electrode catalyst 31 is dispersed, thereby attaching the electrode catalyst 31 to the catalyst holding body 32.

For dispersion of the electrode catalyst 31, reactivity and viscosity with respect to the electrode catalyst 31 are taken into consideration and a solution such as alcohol which does not react with the electrode catalyst 31 is used. That is, in a state that the catalyst holding body 32 is put in the solution, the electrode catalyst 31 is dispersed so as to be introduced into and attached to the fiber stack constituting the catalyst holding body 32, as well as being attached to a surface layer of the fiber stack.

In a different method for the attaching step, liquid particles including the granule type electrode catalyst 31 are dispersed onto the catalyst holding body 32 in order to attach the electrode catalyst 31 to the catalyst holding body 32.

The attaching step includes a sub-step of drying the catalyst holding body 32 after the liquid particles are dispersed or after the electrode catalyst 31 is dispersed.

Besides, various methods such as liquid phase infiltration, precipitation, liquid particle spray, dry spray, etc. can be used to attach the electrode catalyst 31 to the catalyst holding body 32.

The forming step includes the steps of: press-molding the catalyst holding body 32 with the electrode catalyst 31 attached to the catalyst holding body 32 by using a roller; and processing the press-molded electrode catalyst support member catalyst holding body 32 to an electrode 30 in a desired size.

The pressed catalyst holding body 32 confines the electrode catalyst therein, and even if a fluid is transmitted through the catalyst holding body 32, the electrode catalyst 31 cannot flow out.

In the press-molding step, the pair of catalyst holding bodies 32 with the electrode catalyst 31 attached to the catalyst holding body 32 can be press-molded in such a manner that the surfaces on which the electrode catalyst is attached mutually overlap with each other.

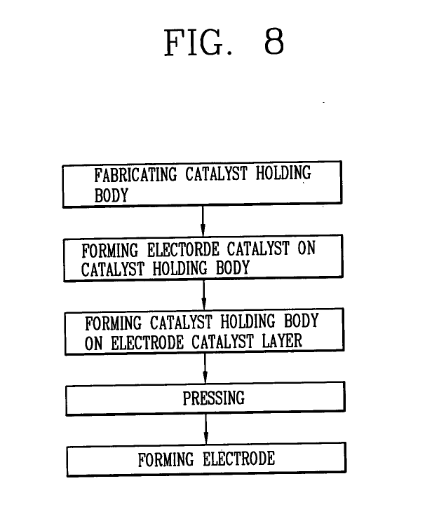

FIG. 8 is a flow chart of a process of manufacturing the electrochemical battery of FIG. 6.

A method for manufacturing an electrode of an electrochemical battery in accordance with the second embodiment of the present invention includes the steps of: forming an electrode catalyst layer 61 made of an electrode catalyst 31 on a first catalyst holding body 62 made of a fiber stack of conductive metal material; and forming a second catalyst holding body 63 made of a fiber stack of conductive metal material on the electrode catalyst layer 61 formed on the first catalyst holding body 62, the second catalyst holding body 63 making a pair with the first catalyst holding body 62.

The electrode catalyst 31 preferably may have a filament form, and more preferably a granule form.

In the method for manufacturing a battery in accordance with the second embodiment of the present invention, after the step of forming the catalyst holding bodies, a molding and processing step can be additionally provided in which the first and second catalyst holding bodies 62 and 63 with the electrode catalyst 31 attached thereto are press-molded by using a roller or the like, and processed into the electrode 30 of a desired size.

The battery in accordance with the second embodiment of the present invention can be applied in the same way except for the descriptions for the battery in accordance with the first embodiment.

As so far described, the electrochemical battery, its electrode and the method for manufacturing the electrode of the present invention have the following advantages.

That is, the manufacturing method is simple and the battery can be small in volume and has a high flexibility and durability. In addition, the specific surface area of the electrode catalyst is high.

The battery of the present invention has an improved efficiency compared to that of the conventional art.

In addition, since the catalyst holding body of the electrode is made of the fiber stack, alkali fuel with a low surface tension can be easily infiltrated due to a capillary phenomenon, thereby enhancing an efficiency of the battery.

It will be apparent to those skilled in the art that various modifications and variations can be made in electrochemical battery of the present invention without departing from the spirit or scope of the invention. Thus, it is intended that the present invention cover modifications and variations of this invention provided they come within the scope of the appended claims and their equivalents.

1. An electrode of an electrochemical battery comprising:
an electrode catalyst; and
a catalyst holding body for holding and confining the electrode catalyst by being entangled with the electrode catalyst.

2. The electrode of claim 1, wherein the electrode catalyst has a granule type.

3. The electrode of claim 1, wherein the electrode catalyst has a filament form.

4-33. (canceled)

34. The electrode of claim 1, wherein the electrode catalyst is formed as an aggregation of fine fibers.

35. The electrode of 1, wherein a surface of the electrode catalyst is coated with nickel.

36. The electrode of claim 1, wherein the electrode catalyst is metal halide.

37. The electrode of claim 1, wherein the electrode catalyst is hydrogen storage alloy.

38. The electrode of claim 1, wherein the catalyst holding body is an aggregation of fibers made of a conductive metal material.

39. The electrode of claim 38, wherein the fiber has a length of 10˜10,000 μm.

40. The electrode of claim 38, wherein the fiber has a diameter of 1˜100 μm.

41. The electrode of claim 1, wherein the catalyst holding body is nickel or nickel alloy.

42. The electrode of claim 1, wherein the catalyst holding body contains fluoro polymer.

43. The electrode of claim 42, wherein the fluoro polymer is PTFE.

44. An electrode of an electrochemical battery comprising:
an electrode catalyst in a power form; and
a catalyst holding body formed as a thin plate, having a fiber tissue entangled with the electrode catalyst, and holding and confining the electrode catalyst therein.

45. The electrode of claim 44, wherein the fiber of the fiber tissue has a length of 10˜10,000 μm and a diameter of 1˜100μ.

46. An electrode of an electrochemical battery comprising:
an electrode catalyst in a power form; and
a catalyst holding body formed as a thin plate having a porous tissue, and holding and confining the electrode catalyst therein.

47. The electrode of claim 46, wherein the porous tissue is formed as one line.

48. An electrode of an electrochemical battery comprising:
a multi-type catalyst holding body formed as two thin plates each having a fiber tissue are attached to each other; and
a power type electrode catalyst confined between the two thin plates.

49. The electrode of claim 48, wherein the multi-type catalyst holding body has a wave form.

50. An electrochemical battery having the electrode of claim 1.

51. A method for fabricating an electrode of electrochemical battery comprising:
a first step of fabricating a catalyst holding body having fine spaces; and
a second step of holding and confining an electrode catalyst in the catalyst holding body, the catalyst holding body and the power type electrode catalyst being entangled with each other.

52. The method of claim 51, wherein the second step comprises:
spraying liquid particles containing the electrode catalyst to the catalyst holding body;
drying the liquid particle-sprayed catalyst holding body; and
compressing the dried catalyst holding body.

53. The method of claim 51, wherein the second step comprises:
dissolving the power type electrode catalyst in a solution;
soaking the catalyst holding body in the electrode catalyst-dissolved solution;
taking out the catalyst holding body and drying it; and
compressing the dried catalyst holding body.

54. A method for fabricating an electrode of an electrochemical battery comprising:
fabricating a thin plate-type catalyst holding body having a fiber tissue;
depositing a power-type electrode catalyst at one surface of the catalyst holding body to form an electrode catalyst layer; and
attaching two electrode catalyst layer-formed catalyst holding bodies to each other in such a manner that the electrode catalyst layers contact with each other.

55. The method of claim 54, wherein the two electrode catalyst layer-formed catalyst holding bodies are attached by compressing.

56. The method of claim 54 further comprising:
bending the two catalyst holding bodies as attached in a wave form.
